(19) United States
(12) Patent Application Publication
(10) Pub. No.: US 2009/0228516 A1
(43) Pub. Date: Sep. 10, 2009

(54) Harmful algae indexing (HaiDex) method

(75) Inventors: John Jianhua Liu, Kowloon (CN); Jia Yan, Kowloon (CN); Samuel Chun-lap Lo, Kowloon (CN); Kin-chung Ho, Kowloon (CN); Tsz Leung Yip, Kowloon (CN)

Correspondence Address: The Hong Kong Polytechnic University, Partnership Development Office, Rm R1007 10/F, Shirley Chan Building, Hung Hom Kowloon, HK

(73) Assignee: The Hong Kong Polytechnic University, Hong Kong (HK)

(21) Appl. No.: 12/073,723

(22) Filed: Mar. 10, 2008

(51) Int. Cl. G06F 17/30

(52) U.S. Cl. 707/102; 707/E17.044

(57) ABSTRACT

Harmful algal bloom (HAB, also termed red tide) has increasingly caused tremendous damage to fisheries worldwide. Since the formation process of HAB is still to be uncovered and the causes of HAB occurrence are largely unknown, it is impossible to take effective measures of prevention. At the present, the only viable measure against HAB is to forewarn and predict the occurrence of large scale HAB, which relies on a viable and efficient indexing method. Unfortunately, there is currently no reliable method to forewarn the occurrence of HAB. The HaiDex method is of a diffusion-characterized water pollution indexing technology, which is invented to effectively forecast HAB, independent of water regions around the world. To ensure forecast accuracy, the HaiDex method is invented (and claimed) to: 1) Characterize statistically a continuous formation process with imperfect panel data of water quality (e.g., missing and censored measures on factors such as water temperature and pollutant concentration, etc,); 2) Develop computationally monitoring multi-dimensional measures of water quality with adaptive filtering and updating (e.g., identifying insensitive measures); 3) Assess dynamically the likelihood of occurrence of harmful algal bloom, in the presence of discrete chaotic events, regime switching and contingent reactions.

Key invention items of HaiDex method include: 1) MCMC Diffusion Simulator to computationally characterize the formation process of HAB by applying MCMC simulation (i.e., Markov chain, Monte Carlo simulation), which can be programmed on mainframe computing facility or PC with statistics software supports such as SAS and STATA. 2) Adaptive Bayesian Validation and Discrete-Choice Modeling to statistically assess the likelihood of chaotic events and regime changes, which can be developed with general econometrics and statistics software, such as STATA.

### I. BACKGROUND

“Harmful algal bloom” (HAB) or red tide, has historically been referred to as “[a] water color change due to outbreaks of microscopic plankton which can sometimes cause death of fish and other animals, irrespective of the color.” (Okamura, Akasio ni tuite (on the red tides), J. Imperial Fish. Inst., 12, 26-41). This understanding has been modified to include the rapid growth of marine microscopic organisms that can cause mass mortality of marine animals.

HAB has continuely occurred, for example, in the years 731, 875, 1216, 1225, 1227, 1234, 1247, 1252, and 1312 AD in Japan. In the last century, occurrences have been worldwide, including India (1917, 1949-1951), France (1993), U.S. (1941, 1952-1974), and South Africa (1948).

In the past two decades, HAB has increasingly caused tremendous damage to fisheries worldwide. The HAB occurrences and their magnitude and economic impact have increased dramatically in the South China Sea. The red tide problems are worsening due to the regional expansion of aquaculture, coastal development and international maritime traffic. The worst and largest HAB in Hong Kong occurred in 1998. The estimated loss of fish fries was US$70 million without counting cost of compensation and cleaning up programs. Further, HAB is not just a costal problem. In the later weeks of May 2007, in Lake Tai in Jiangsu province in China, a fast-spreading, foul-smelling blue-green algae bloom occurred almost overnight. The end results are foul-adored, yellow water emanating from water taps and showers. The water supply system including that of drinking was affected, and millions Chinese relying on Lake Tai for water supply were affected. The city placed a ban on price hikes on bottled clean water and other related items as well as threatened hefty fines to violators. A report said that a Wal-Mart store imposed rations of 24 bottles per person! Bottled water had to be brought in from neighboring cities and provinces for emergency use. The livelihood of millions was affected and the amount of financial damage is astronomical! Given that drought and increased withdrawals for consumptive uses in fresh water lakes, there will be increasing occurrence of fresh-water algal blooms! There are many large fresh water lakes as well as reservoirs in Chinese Mainland and many other countries; impact of HAB attack could be of catastrophic scale.

The factors leading to an algae outbreak are not fully known, but likely include meteorological conditions, oceanic conditions, oceanic structure, growth stimulators, inhibitor removal, human impact, nutrient concentration, water quality/conditions, and organic substance concentration. As far as the study of HAB has been advanced, the formation process of HAB still needs to be scientifically characterized and the causes of HAB occurrence largely remain unknown. Consequently, effective measures of HAB prevention are beyond attainable, leaving forecast and prediction as the only viable measure against HAB. However, forecasting and prediction require scientific characterization of formation process and accurate data monitoring and collection. Since the scientific knowledge of the HAB formation is rather limited, implementable method of HAB forecasting remains seriously lacking.

The need for a viable HAB forecasting method is worldwide, way beyond just Asian region. For example, the State of The Salmon—a joint program of Wild Salmon Center and Ecotrust (Website: //www.stateofthesalmon.org), which aims to create a knowledge network across Pacific Rim about the state of salmon as one of the most important fisheries in the world, is in the process of developing Near Shore Indicators for Salmon fishery, which requires a Red-Tide indexing system to be developed (see more in Attachment 1: State of the Salmon Program.). Speaking just before the operation of the National Oceanic and Atmospheric Administration (NOAA) HAB observation and forecasting system of the US Department of Commerce (on Sep. 30, 2004), retired Navy Vice Adm. Conrad D. Lautenbacher, Undersecretary for Commerce for Oceans and Atmosphere and NOAA Administrator said: “Using observational data for ecological forecast systems shows the value and need for the development of an integrated ocean observing system, one that can assist in addressing the threats to our health and economy caused by harmful algal blooms” (http://www.noaanews.noaa.gov/stories2004/s2323.htm.)

Despite the urgent and wide-range needs for the development of a HAB forecasting technology, there is currently no systematic method to forewarn the occurrence of HAB. Search Results on HAB Relevant Patents confirms that there is no HAB or red tide related patents according to the database of US Patents and Trademarks Office (USPTO).

### II. DESCRIPTION

As an alternative to direct time-series forecasting, indexing method, such as that of stock indices, is a proven empirical technology for indicative forecasting of dynamic processes with high degree of uncertainty and complexity, such as an environment pollution process in general and a HAB process in particular. Indeed, the present HaiDex method is a diffusion-characterized water pollution indexing technology suited for HAB forecasting and related applications, and expandable for other pollution related applications. HaiDex method is based on the postulate that oceanic pollution is a multi-dimension diffusion characterized with two categories of characteristics, namely, differential characteristics (of diffusion drift and disturbance) and the other of contingent characteristics (of pollution threshold and occurrence).

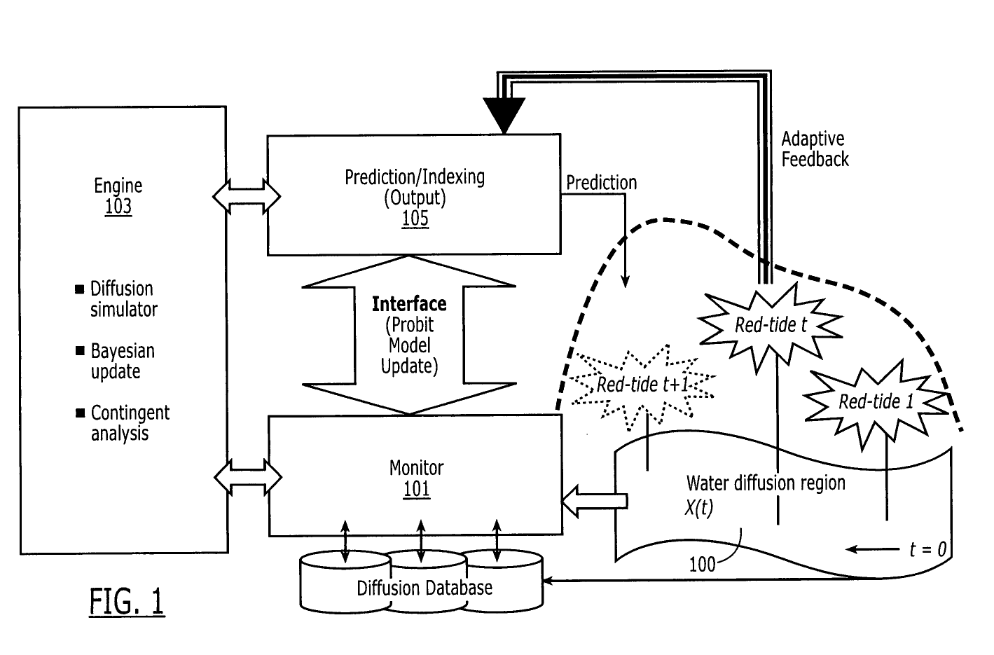

FIG. 1 is the HaiDex method consisting of three software modules;

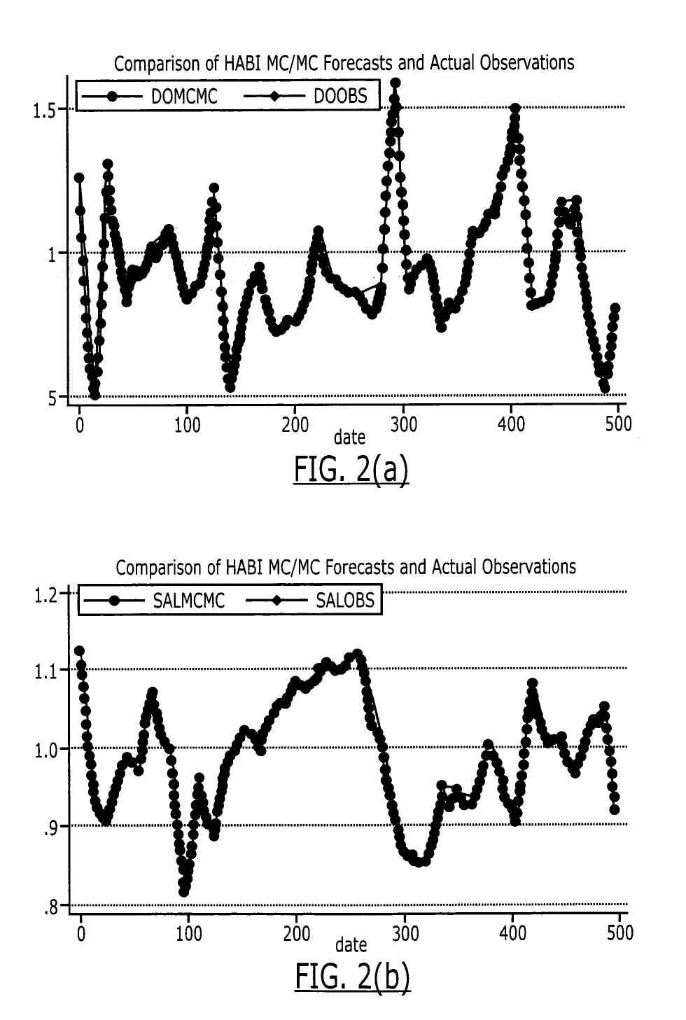

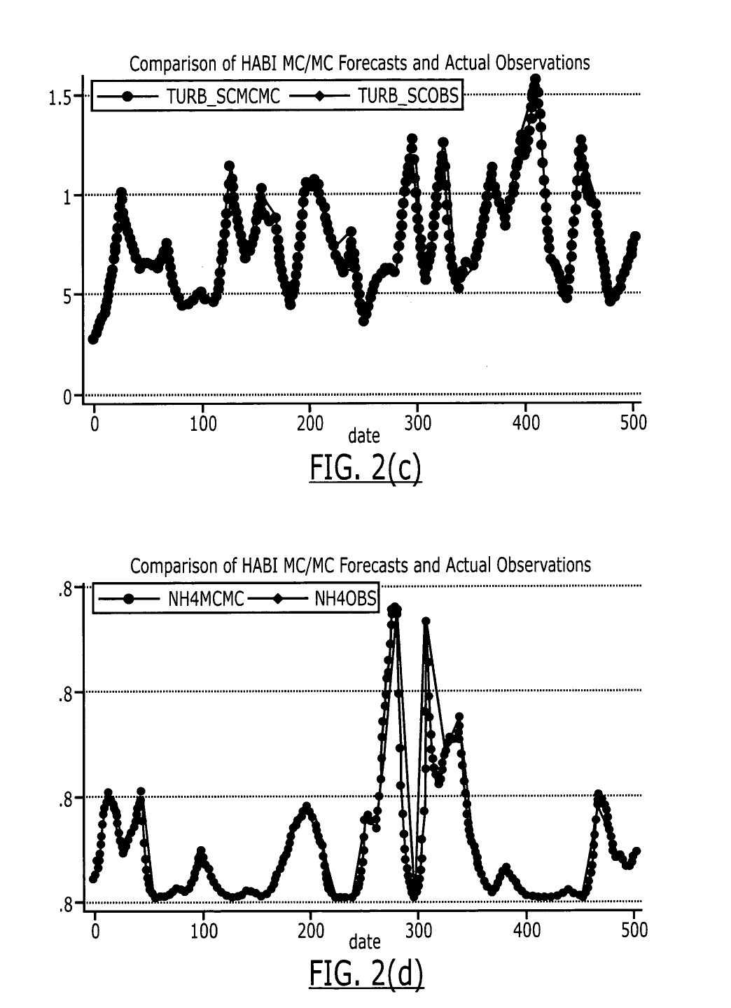

FIG. 2 shows the MC/MC simulated forecasts by the HaiDex system compared with the actual observation data, period by period.

Schematic Design of HaiDex Method (FIG. 1)

1. HaiDex Monitor Module (101):
Dynamic input data measuring and processing
Characteristics validation and calibration
Input dimension reduction
Input formatting and interfacing

2. HaiDex Engine Module (103):
Diffusion-characterized MCMC Simulator: Model validation and modification
Adaptive parameters identifier: Occurrence forecasting
Adaptive non-smooth analyzer: Duration forecasting
Dynamic hybrid process synthesizer: Index calculation and generation

3. HaiDex Output Module (105):
Output: prediction and indexing
Adaptive feedback: prediction error analysis
Model validation and reconfiguration

In summary, HaiDex method is invented to:
1) Produce HAB forecasts, independent of water regions around the world
2) Characterize statistically a continuous formation process with imperfect panel data of water quality (e.g., missing and censored measures on factors such as water temperature and pollutant concentration, etc,)
3) Develop computationally monitoring measures of water quality with adaptive filtering and updating (e.g., identifying insensitive measures)
4) Assess dynamically the likelihood of occurrence of harmful algal bloom, in the presence of discrete chaotic events, regime switching and contingent reactions.

The Monitor module 101 is designed to generate empirical measurements of both categories of characteristics, by interacting with the Engine module to develop and maintain a dynamic database of regional quality and HAB occurrence. Monitor can receive both panel data of differential characteristics of HAB formation and contingent data of HAB occurrence, and interact with Engine and Output modules to update and maintain a dynamic database.

The Engine module 103 of HaiDex method include: 1) MCMC Diffusion Simulator to computationally characterize the formation process of HAB by applying MCMC simulation (i.e., Markov chain, Monte Carlo simulation), which can be programmed on mainframe computing facility or PC with statistics software supports such as SAS and STATA. 2) Adaptive Bayesian Validation and Discrete-Choice Modeling to statistically assess the likelihood of chaotic events and regime changes, which can be developed with general econometrics and statistics software, such as STATA.

MCMC Diffusion Simulator is independent of water regions, and is adaptive, i.e., to learn from the past data and to expand from the statistics, using MCMC simulation (i.e., Markov chain, Monte Carlo simulation). Using MCMC simulation, the HaiDex Engine can augment and filter imperfect panel data of differential characteristics. One important application of this important and critical feature is to interpolate and extrapolate statistically missing and censored diffusion data. It is inevitable that panel data collected from the field contains missing and erroneous data entries, which must be augmented for those missing, and corrected for those wrong. This can be evidenced from our ongoing experiment on applying HaiDex method conducted on HAB forecasting for To-Lo Habor in Hong Kong (see detail in Section IV).

The Output model 105 generates forecasts of time and duration of future HAB occurrences, collects feedback forecast signals (e.g., forecast errors), and interacts with Monitor and Engine to improve accuracy of HAB measurements and indices.

### III. THE MODEL

### Identifying ELAB Diffusion Characteristics

According to the well-established diffusion theory, the formation of HAB can be characterized as a diffusion process. Given n water attributes in the formation of HAB, an HAB formation process is model as an n-dimension Ito diffusion process, in the following form:

dxₜ=a(xₜ;Θ)dt+σ(Θ)dwₜ

where
xₜ represents an n-vector state of attributes at time t, including bio-chemical attributes (e.g., NH4 and PO2, etc.) and physical attribute (e.g., temperature, etc.)
a(-;-) is an n-vector drift function
Θ represents an m-vector system parameter, i.e., diffusion coefficients associated with the differentials of individual state attributes, which characterize the diffusion process along each dimension of attributes (e.g., temperature, NH4, etc.)
σ(·) is an n×n matrix of disturbance functions
wₜ is an n-dimension Weiner process, and the differential dwₜ is an n-dimension Brownian motion

The functional forms of drift a(.;.) and disturbance a are region-specific, which must be identified according to specific regions concerned. The HaiDex system includes the development of model identification and specification methods and tools. Then, system parameters, along with their probability distributions, are to be estimated using collection of sample data, before the model can verified and validated by both simulated data and actual sample data as well.

### HAB Occurrence Forecasting

Let U ⊂ R be a real-valued occurrence-threshold set, and let X ⊂ ″ be the state-space of attributes xₜ. We then define an occurrence-threshold mapping, u:X×Θ→R, such that the HAB occurrence indicator, denoted by yₜ, can be expressed as following:

$${y}_{t} = {1}_{[ u ∈ U ]} = \{ \begin{matrix}1 , & if u ∈ U \\ 0 , & otherwise\end{matrix}$$

The key to accurate forecasting of HAB occurrence rests on identification of the occurrence-threshold set. The HaiDex system includes the development of methods and tools to identify and specify the region-specific occurrence-threshold set.

Comprehensive field experiments have been conducted to test the HaiDex system. The results confirm that the HaiDex system performs to all the objectives designed, and that the system is trainable and adaptive for different applications.

The method of using the Haidex system involves collecting time sense data 100, comparing said time sense data with historical data within the monitor 101, identifying imperfect data, delivering said imperfect data to the engine 103, determining diffusion characteristics, filtering the diffusion characteristics, and calculating said index 105.

Collecting time series data 100 includes data selected form the group consisting of Data includes but is not limited meteorological conditions, oceanic conditions, water temperature, water salinity concentration, organic substance concentration, trace metal concentration, organic substance concentration, physiological characteristics of algal organisms, pollutant concentrations, water pH, inhibitory concentration, storm surges, light intensity, precipitation, air temperature, wind speed, spring tide, neap tide, river discharge, upwelling, convergent flow, thermouline, nutrients in upper layer, nutrients in lower layer, dissolved oxygen, predators, cyst suspension, cyst germination, growth rate, abundance, accumulation, and historical data.

Data can be collected by methods well-known in the art, including qualitative observation, measurement readings, test tube samples and analysis, instrument analysis such as spectrometry, probe reading, and the like. Collection can occur in the field or determined in the lab. As used herein, collection refers to both physically collecting evidence and analyzing such evidence for the desired data.

Comparing said time series with historical data within the monitor 101 includes drawing both data types into the monitor and delivering points of imperfect data or error signal. Historical data is any data that has come before the time series data. Imperfect data is any data that is determined inaccurate based on the historical data norm, any data that is missing, and the like. Following the delivering of the imperfect data to the engine 103, diffusion characteristics are determined selected from the group consisting of differential diffusion characteristics, contingent diffusion characteristics, and stochastic diffusion characteristics, i.e., contingent and differential characteristics.

Filtering occurs during determining diffusion characteristic, whereby the engine 103 continually interacts with the monitor to obtain more imperfect data.

The engine produces an index, i.e., a single read number calculated from the data inserted into the engine, via the diffusion characteristics formula previously mentioned. The HAB occurrence forecasting occurs via the HAB occurrence forecasting model as previously mentioned.

### IV. SYSTEM DEVELOPMENT AND SYNTHESIS: EXPERIMENTS AND APPLICATIONS EXPERIMENTAL DEVELOPMENT

A specific HaiDex system is developed and then applied to red-tide forecasting of To-Lo Harbor water region in Hong Kong. For the purpose of system development, a comprehensive data bank is established, containing panel data sets collected from 1994 to 2004. The data are then processed by HaiDex Diagnostic Monitor in accordance with the format specified and required for HABI Diagnostic Engine, as illustrated in the following Table 1 of sample input data (reduced dimension of 12 attributes):

TABLE 1
Sample Input Data and Statistics

| Variable | Obs | Mean | Std. Dev. | Min | Max |
|---|---|---|---|---|---|
| TEMPER | 403 | 23.90126 | 4.815387 | 11.7 | 33.199 |
| SAL | 400 | 29.75851 | 2.735876 | 14.549 | 33.666 |
| DO | 401 | 8.394042 | 2.297607 | 2.53 | 17.033 |
| TURB_SC | 402 | 3.669224 | 2.253859 | .26 | 18 |
| NH4 | 405 | .1422173 | .1441525 | .005 | .99 |
| NO3 | 405 | .0471086 | .0745467 | .001 | .6 |
| TKN_SP | 405 | .7465284 | .4106936 | .11 | 3.5 |
| PO4 | 405 | .0326568 | .0343447 | .001 | .235 |
| TP_SP | 405 | .1062049 | .0969392 | .02 | 1.3 |
| SIO2 | 310 | .6807097 | .773481 | .02 | 7.1 |
| CHL | 405 | 15.92127 | 15.57937 | .13 | 130 |
| TIN | 405 | .1989728 | .1987733 | .007 | 1.171 |

The actual dimension of attributes in original data is much greater than 12 as listed above. Even with a dimension of 12 attributes, it is already beyond the tractability of current solution methods for diffusion problems. Interacting with the HABI Engine and simulators, a specific HaiDex Diagnostic Monitor is developed, so as to accurately characterize the specific red-tide formation process by identifying the types and parameters of underlying diffusion model, and to reduce the dimension of inputs by identifying and selecting the key attributes.

### Experimental Applications: Simulated Red-Tide Diffusion

The developed specific HaiDex system (including HaiDex Monitor and Engine) is then applied to the forecasting of red-tide at To-Lo Harbor area. Specifically, starting from period 1 of a 500-period time horizon, the developed HaiDex system generates a simulated forecast for the next period, and carries on period by period until the last period of 2004. The MC/MC simulated forecasts by the HaiDex system are then compared with the actual observation data, period by period, as illustrated in FIG. 2 of some sample results and comparisons.

The results of the extensive experiments and tests suggest that the developed HaiDex system is verifiably applicable for accurate characterization of red-tide formation process at the specified water region. Since March 2007, a red-tide research group has been assembled and led by Prof. KC Ho (of HK Open U.), is devoted to collecting and analyzing red-tide data from To-Lo Harbor area, on an ongoing basis. The developed HaiDex system is being tested, on an ongoing basis, on the updated database produced by the Prof. Ho's group, and the results of the ongoing tests are very encouraging and promising.

1. A method of generating an index, comprising the steps of:
collecting time series data of water quality;
delivering said data to an engine;
determining diffusion characteristics of said water quality from said engine;
comparing the diffusion process with historical data on red-tide occurrence within a monitor;
updating the method of calculating said index;
filtering said diffusion characteristics; and
calculating said index.

2. The method of generating an index in claim 1, wherein said time-series data is selected from the group consisting of meteorological conditions, oceanic conditions, water temperature, water salinity concentration, organic substance concentration, trace metal concentration, organic substance concentration, physiological characteristics of algal organisms, pollutant concentrations, water pH, inhibitory concentration, storm surges, light intensity, precipitation, air temperature, wind speed, spring tide, neap tide, river discharge, upwelling, convergent flow, thermouline, nutrients in upper layer, nutrients in lower layer, dissolved oxygen, predators, cyst suspension, cyst germination, growth rate, abundance and accumulation.

3. The method of generating an index in claim 1, wherein said diffusion characteristics can be stochastic diffusion characteristics, contingent diffusion characteristics, or differential diffusion characteristics.

4. The method of generating an index in claim 1, wherein determining diffusion characteristics comprises utilizing an n-dimension I to diffusion process in the form
dxₜ=a(xₜ;Θ)dt+σ(Θ)dwₜ

5. The method of generating an index in claim 1, wherein said index can be harmful algal bloom index, or water quality index.

6. The method of generating an index in claim 5, wherein said index is a red number.
